(19) United States
(12) Patent Application Publication
(10) Pub. No.: US 2010/0266737 A1
(43) Pub. Date: Oct. 21, 2010

(54) ANTIOXIDANT STABILISATION OF NUTS AND SEEDS AND OF PRODUCTS CONTAINING THE SAME

(76) Inventors: Majda Hadolin Kolar, Zetale (SI); Ohad Cohen Ovadya, Zichron Yaakov (IL); Harold Wiener, Jerusalem (IL); Maja Skrinjar, Ptuj (SI); Andreja Rizner Hras, Race (SI); Miran Bezjak, Markovci (SI)

Correspondence Address: Pearl Cohen Zedek Latzer, LLP, 1500 Broadway, 12th Floor, New York, NY, 10036, US

(21) Appl. No.: 12/747,310

(22) PCT Filed: Dec. 10, 2008
(86) PCT No.: PCT/IL08/01577

§ 371 Date: Jun. 10, 2010

(30) Foreign Application Priority Data
Dec. 10, 2007 (SI) P-200700321

(51) Int. Cl. A23B 9/26

(52) U.S. Cl. 426/293; 426/310; 426/289

(57) ABSTRACT

The subject of the invention is antioxidant stabilisation and protection of nuts and/or seeds etc. and of products containing nuts and/or seeds. As known, nuts and seeds become rancid over time, and although several methods of preserving the same exist, including cooling, vacuum packaging, and the use of synthetic stabilizers, there is a need for improved methods of preserving nuts and seeds, as well as products comprising the same. According to this invention antioxidant extracts of plants from the Labiatae family, such as rosemary, sage, balm, oregano, summer savory, mint and thyme, which are natural antioxidants, are used for stabilisation nuts and/or seeds, as well as products comprising the same.

### FIELD OF THE INVENTION

The subject of the invention is a method for the stabilisation and protection of nuts, seeds and products containing nuts and/or seeds. Specifically, the method for stabilization and protection of nuts, seeds and products comprising the same includes the use of antioxidant extracts of plants from the Labiatae family.

### BACKGROUND OF THE INVENTION

As known to those familiar in the art, nuts, e.g., walnuts, hazelnuts, peanuts and almonds, and seeds, such as sunflower seeds, pumpkin seeds, flax seeds, sesame seeds, as well as products comprising the same, such as bakery products, confectioneries, snacks, spreads, etc., are prone to spoilage. This spoilage is enhanced by removing the shell from the nuts and is influenced also by external conditions, such as temperature and humidity. Since the polyunsaturated fats in nuts and seeds break down easily, especially due to oxidation, the nuts and seeds may turn rancid, thereby damaging both their taste and their nutritional value. Rancidity can cause irritation of the stomach and intestinal lining, and further, rancid nuts and seeds contain free radicals that can contribute to poor immunity, cancer and other chronic diseases.

Methods known today for preserving nuts and seeds include keeping them in the refrigerator or the freezer. However, although cooling methods preserve the nuts/seeds for an additional length of time (about one month in the refrigerator and one year in the freezer), such cooling may be inconvenient. Further, refrigerating and freezing is not appropriate for many product containing nuts and/or seeds.

Other preservation methods used today include vacuum packaging and packaging in inert atmospheres. However, such packaging may at times damage the quality of the packaged goods, especially when products containing nuts/seeds are packaged, rather than the nuts/seeds themselves.

Another method used in the art is adding antioxidants into the oil used for roasting the nuts/seeds. However, the main synthetic antioxidant in use today is tent-Butylhydroquinone (TBHQ), which is controversial regarding its possible negative health effects. Therefore, TBHQ is prohibited in several countries.

In light of the above disadvantages, there is a long felt need for new and advantageous methods of preserving nuts, seeds and products comprising the same. Further, since the spoilage of the nuts and seeds is mainly caused by oxidation and since the synthetic antioxidants have negative health effects, there is a need for a natural antioxidant for preserving nuts, seeds and products comprising the same.

Several plant extracts, specifically from the Labiatae family, are known to be natural antioxidants. The main antioxidant ingredients in the extracts of Labiates are carnosic acid, carnosol and derivatives thereof, which act as hydrogen atom donors.

It is therefore an object of this invention to provide a method for stabilizing and preserving nuts, and seeds, as well as products comprising the same using natural antioxidants.

### SUMMARY OF THE INVENTION

The invention provides a method for stabilization and protection of whole, broken or ground nuts, seeds and/or products containing the same, comprising applying a composition comprising an antioxidant extract of at least one plant from the Labiatae family to said nuts, seeds and/or products containing the same.

In an embodiment of the invention, the composition comprises a diluent. diluent is selected from maltodextrin, salt, sugar, a condiment, edible oil, or any other food approved diluent or any combination thereof. In an embodiment of the invention, the amount of the diluent is 90-99% of the composition.

In an embodiment of the invention, the composition comprises 0 to 50% by weight of carnosic acid, 0 to 10% by weight of carnosol and 0 to 6% by weight of methyl-carnosol.

In an embodiment of the invention, the composition is added to the nuts, seeds, or products comprising the same, in a concentration of 0.005-0.1% by weight with respect to the fat.

In an embodiment of the invention, the composition is applied in powder form.

In an embodiment of the invention, the composition is applied in solution form. The solution form comprises ethanol or edible oil according to some of the embodiments.

In an embodiment of the invention, the composition is applied to the nuts or seeds during their roasting or coating with or without additional fat.

In an embodiment of the invention, an emulsifier is added to the composition. The emulsifier according to some embodiments of the invention is DATEM.

In an embodiment of the invention, the emulsifier is added in an amount of 0.5-5% by weight.

In an embodiment of the invention, the composition is added to an ingredient of a product, wherein the final product will contain nuts and/or seeds.

All the above and other characteristics and advantages of the present invention will be further understood through the following illustrative and non-limitative description of preferred embodiments thereof.

### BRIEF DESCRIPTION OF DRAWINGS

FIG. 1: shows the results of a Rancimat test of fat isolated from walnuts with and without added rosemary extract with antioxidant properties;

FIG. 2: shows the results of measurement of the peroxide number of fat isolated from walnuts with and without added rosemary extract with antioxidant properties;

FIG. 3: shows the results of measurement of the anisidine number of fat isolated from walnuts with and without added rosemary extract with antioxidant properties;

FIG. 4: TOTOX number of fat isolated from walnuts with and without added rosemary extract with antioxidant properties.

### DETAILED DESCRIPTION OF THE EMBODIMENTS

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

As mentioned above, the spoilage of nuts and seeds is caused mainly by oxidation. Therefore, according to this invention, a composition comprising an extract with antioxidant properties is used in order to stabilize and preserve nuts, seeds and products comprising the same.

Since this invention is directed to food products, it is essential that the antioxidants used are edible and non-toxic. Thus, according to this invention, the antioxidants used are antioxidant extracts from the Labiatae family, which are known to be consumed safely by humans. The Labiatae family includes, but is not limited to, rosemary, sage, balm, oregano, summer savory, mint and thyme.

The main active ingredients in antioxidant extracts of plants from the Labiatae family are carnosic acid, carnosol and derivatives thereof.

An antioxidant extract of plants from the Labiatae family contains 0 to 50% by weight of carnosic acid, 0 to 10% by weight of carnosol and 0 to 6% by weight of methyl-carnosol. The amount of such extracts needed for preserving nuts, seeds, or products comprising the same, is small, and therefore, it is very difficult to equally distribute a pure antioxidant extract on the product that is to be stabilized. Therefore, according to an embodiment of this invention, a diluted extract is used for the stabilization. The extract may be diluted by any adequate diluent, such as for example, without being limited, maltodextrin, salt, sugar, a condiment, or any combination thereof.

According to this invention, an antioxidant extract of at least one plant from the labiatae family containing 0 to 50% by weight of carnosic acid, 0 to 10% by weight of carnosol and 0 to 6% by weight of methyl-carnosol is added to nuts, seeds or products comprising the same in a concentration of 0.005-0.1% by weight calculated with respect to fat. Such extracts do not cause organoleptic changes in the nuts, seeds or the products containing the nuts and/or seeds.

The antioxidant extract of plants from the labiatae family is used in the following ways:

According to one embodiment of this invention, a diluted antioxidant extract of plants from the Labiatae family is prepared by adding 90-99% by weight of an adequate diluent to 1-10% by weight of antioxidant extract of Labiates.

The invention is further directed to processes of applying antioxidant extracts of plants from the Labiatae family to nuts/seeds and products comprising the same for stabilization thereof.

According to an embodiment of the invention, the stabilization process includes mixing whole or ground nuts and/or seed with a diluted antioxidant extract of plants from the Labiatae family in powder form. As mentioned above, the diluent may be any appropriate material, such as maltodextrin, salt, sugar, a condiment, or any combination thereof.

According to another embodiment of this invention, the stabilization process includes preparation of a solution of an antioxidant extract of plants from the Labiatae family in ethanol, sprinkling whole or ground nuts and/or seeds with the ethanol-extract solution, and drying at a temperature ranging from 20-60° C. According to one embodiment of this invention, the solution of the antioxidant extract of Labiates in ethanol is prepared by dissolving 1 g of antioxidant extract in 50-100 mL of ethanol, and mixing at room temperature for at least 15 minutes.

According to yet another embodiment of this invention, the stabilization process includes preparation of a solution of an antioxidant extract of plants from the labiatae family in edible oil and sprinkling whole or ground nuts and/or seeds with a solution of the extract.

According to one embodiment of this invention, the solution of the antioxidant extract of Labiates in edible oil is prepared by dissolving 1 g of antioxidant extract of labiates in 50-100 mL of edible oil, and mixing at a temperature of 40-60° C. for 15 minutes.

According to a further embodiment of the invention, the whole or ground nuts/seeds are roasted/coated with fat to which an antioxidant extract of plants from the Labiatae family has been added.

According to an additional embodiment of this invention, the whole or ground nuts/seeds are roasted/coated with an antioxidant extract of plants from the Labiatae family, without the addition of fat.

According to a further embodiment of this invention, salt, sugar and any other appropriate condiment may be added to the nuts/seeds before or after roasting/coating the same with the antioxidant extract.

Once the nuts/seeds are preserved using any of the above processes they may be added into various food products, with or without grinding. According to an additional embodiment of this invention, the antioxidant extract of plants from the Labiatae family may be added directly into a product or product ingredient, wherein the final product will contain nuts and/or seeds. According to this embodiment, the extract added to such products may be either diluted or not. Any appropriate diluent may be used, such as edible oil.

According to a further embodiment of the invention, an emulsifier may be added to the antioxidant extract of the plants from the Labiatae family in order to achieve a better permeation into the interior of the nuts/seeds. According to one embodiment of the invention, the emulsifier used is di-acetyl tartaric acid ester of monoglyceride (DATEM). According to one embodiment of this invention, the amount of emulsifier used is 0.5-5% by weight.

While embodiments of the invention have been described by way of illustration, it will be apparent that the invention may be carried out with many modifications, variations and adaptations, without departing from its spirit or exceeding the scope of the claims.

The invention will be further illustrated with reference to the following illustrative examples which are not intended to limit the scope of the invention in any manner.

### EXAMPLES

### Example 1

50 mL 96% (v/v) ethanol were added to 1 g of rosemary extract containing 20% by weight of carnosic acid, 5% by weight of carnosol and 3% by weight of methyl-carnosol, and the mixture was stirred for 15 minutes at room temperature.

Walnuts kernels, removed from their shells, were sprinkled with a solution of rosemary extract in ethanol so that the concentration of rosemary extract in comparison to the fat content of the walnuts was 0.005% (0.05 g/kg), 0.02% (0.2 g/kg) and 0.1% (1 g/kg). The kernels were then dried in a dryer for two hours at a temperature of 60° C. The kernels were kept at room temperature for two months. When the storage period was over, fat was isolated from the walnut kernels by extraction, and their oxidation status was measured by a Rancimat test. The peroxide and anisidine values, as well as the oxidation value (TOTOX) of the isolated fat were calculated. A control sample was prepared by the same procedure, without the addition of an antioxidant.

The sample with the added rosemary extract in a concentration of 0.02% (0.2 g/kg) had by 1.8-times longer induction time than the control sample, by 1.7-times lower peroxide value, by 1.8-times lower anisidine value and by 1.7-times lower oxidation value.

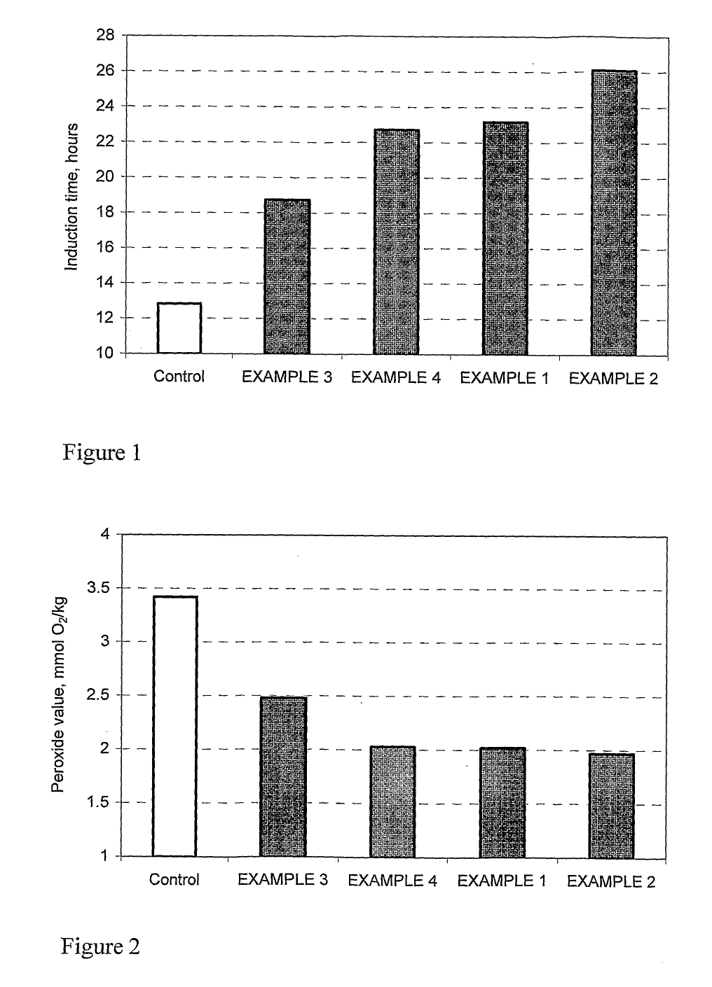

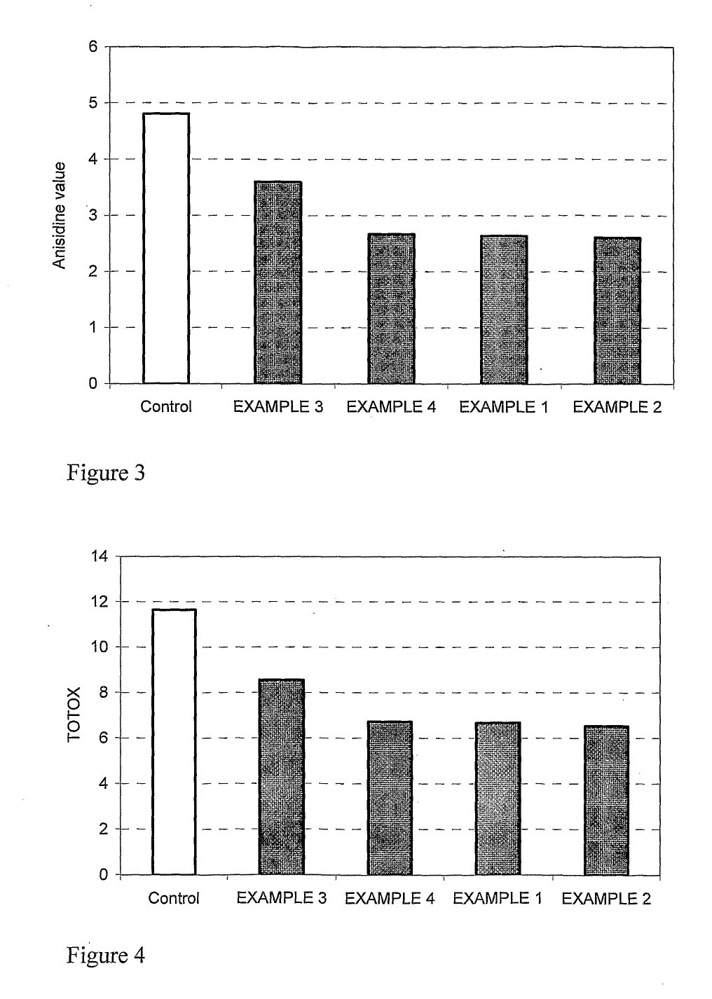

The results are shown in Table 1 and in FIGS. 1, 2, 3 and 4.

### Example 2

50 ml of 96% (v/v) ethanol were added to 1 g of rosemary extract containing 20% by weight of carnosic acid, 5% by weight of carnosol and 3% by weight of methyl-carnosol and the mixture was stirred for 15 minutes at room temperature.

Walnuts kernels, removed from their shells, were sprinkled with a solution of rosemary extract in ethanol so that the concentration of rosemary extract in comparison to the fat content of the walnuts was 0.005% (0.05 g/kg), 0.02% (0.2 g/kg) and 0.1% (1 g/kg). The kernels were then dried at room temperature (T=23° C.). The kernels were kept at room temperature for two months. When the storage period was over, fat was isolated from the walnut kernels by extraction, and their oxidation status was measured by a Rancimat test. The peroxide and anisidine values as well as the oxidation value (TOTOX) of the isolated fat was calculated. A control sample was prepared by the same procedure, without addition of an antioxidant.

The sample with the added rosemary extract in a concentration of 0.02% (0.2 g/kg) had by 2.2-times longer induction time than the control sample, by 1.7-times lower peroxide value, by 1.8-times lower anisidine value and by 1.8-times lower oxidation value.

The results are shown in Table 1 and in FIGS. 1, 2, 3 and 4.

### Example 3

A diluted rosemary extract containing 10% of rosemary extract (20% by weight of carnosic acid, 5% by weight of carnosol and 3% by weight of methyl-carnosol), 5% of emulsifier (DATEM) and 85% of maltodextrin was prepared.

Walnuts kernels, removed from their shells, were powdered by the diluted rosemary extract so that the concentration of rosemary extract in comparison to the fat content of the walnuts was 0.005% (0.05 g/kg), 0.02% (0.2 g/kg) and 0.1% (1 g/kg). The walnut kernels were then kept at room temperature for two months. When the storage period was over, fat was isolated from the walnut kernels by extraction, and their oxidation status was measured by a Rancimat test. The peroxide and anisidine values as well as the oxidation value (TOTOX) of the isolated fat was calculated. A control sample was prepared by the same procedure, without addition of an antioxidant.

The sample with the added rosemary extract in a concentration of 0.02% (0.2 g/kg) had by 1.5-times longer induction time than the control sample, by 1.4-times lower peroxide value, by 1.3-times lower anisidine value and by 1.4-times lower oxidation value.

The results are shown in Table 1 and in FIGS. 1, 2, 3 and 4.

### Example 4

A diluted rosemary extract containing 1% of rosemary extract (20% by weight of carnosic acid, 5% by weight of carnosol and 3% by weight of methyl-carnosol), 5% of emulsifier (DATEM) and 98.5% of maltodextrin was prepared.

Walnut kernels, removed from their shells, were powdered by rosemary extract so that the concentration of rosemary extract in comparison to the fat content of the walnuts was 0.005% (0.05 g/kg), 0.02% (0.2 g/kg) and 0.1% (1 g/kg). The walnut kernels were then kept at room temperature for two months. When the storage period was over, fat was isolated from the walnut kernels by extraction, and their oxidation status was measured by a Rancimat test. The peroxide and anisidine values as well as the oxidation value (TOTOX) of the isolated fat was calculated. A control sample was prepared by the same procedure, without addition of an antioxidant.

The sample with the added rosemary extract in a concentration of 0.02% (0.2 g/kg) had by 1.8-times longer induction time than the control sample, by 1.7-times lower peroxide value, by 1.8-times lower anisidine value and by 1.7-times lower oxidation value.

The results are shown in Table 1 and in FIGS. 1, 2, 3 and 4.

TABLE 1
Results of measurement of oxidation status of walnut kernels
stabilised by various processes and by an addition of rosemary
extract in a concentration of 0.02% (0.2 g/kg).

| | | EXAM- | EXAM- | EXAM- | EXAM- |
|---|---|---|---|---|---|
| | Control | PLE 1 | PLE 2 | PLE 3 | PLE 4 |
| Induction time, h | 12.83 | 23.17 | 26.10 | 18.74 | 22.73 |
| Peroxide number, | 3.42 | 2.02 | 1.97 | 2.48 | 2.03 |
| mmolO₂/kg | | | | | |
| Anisidine number | 4.81 | 2.64 | 2.61 | 3.60 | 2.67 |
| TOTOX | 11.65 | 6.68 | 6.55 | 8.56 | 6.73 |

### Example 5

50 mL of vegetable oil was added to 1 g of rosemary extract containing 20% by weight of carnosic acid, 5% by weight of carnosol and 3% by weight of methyl-carnosol and the mixture was stirred for 15 minutes at a temperature 40-60° C.

Pumpkin seeds were sprinkled with a solution of rosemary extract in vegetable oil so that the concentration of rosemary extract in comparison to the fat content of the pumpkin seeds was 0.005% (0.05 g/kg), 0.02% (0.2 g/kg) and 0.1% (1 g/kg).

The pumpkin seeds were mixed well and kept at room temperature for two months. A control sample was prepared by the same procedure, without addition of an antioxidant. When the storage period was over, fat was isolated by extraction and the oxidation status was measured by a Rancimat test. The sample with the added rosemary extract in a concentration of 0.02% (0.2 g/kg) had by 1.3-times longer induction time than the control sample.

### Example 6

50 mL of vegetable oil were added to 1 g of rosemary extract containing 20% by weight of carnosic acid, 5% by weight of carnosol and 3% by weight of methyl-carnosol and the mixture was stirred for 15 minutes at a temperature of 60° C.

Sunflower seeds were sprinkled with a solution of rosemary extract in vegetable oil so that the concentration of rosemary extract in comparison to the fat content of the sunflower seeds was 0.005% (0.05 g/kg), 0.02% (0.2 g/kg) and 0.1% (1 g/kg).

The sunflower seeds were mixed well and kept at room temperature for two months. A control sample was prepared by the same procedure, without addition of an antioxidant. When the storage period was over, fat was isolated by extraction and the oxidation status was measured by a Rancimat test.

The sample with the added rosemary extract in a concentration of 0.02% (0.2 g/kg) had by 2.6-times longer induction time than the control sample.

### Example 7

50 mL of vegetable oil were added to 1 g of rosemary extract containing 20% by weight of carnosic acid, 5% by weight of carnosol and 3% by weight of methyl-carnosol and the mixture was stirred for 15 minutes at a temperature of 60° C.

Sesame seeds were sprinkled with a solution of rosemary extract in vegetable oil so that the concentration of rosemary extract in comparison to the fat content of the Sesame seeds was 0.005% (0.05 g/kg), 0.02% (0.2 g/kg) and 0.1% (1 g/kg).

The sesame seeds were mixed well and kept at room temperature for two months. A control sample was prepared by the same procedure, without addition of an antioxidant. When the storage period was over, fat was isolated by extraction and the oxidation status was measured by a Rancimat test.

The sample with the added rosemary extract in a concentration of 0.02% (0.2 g/kg) had by 1.7-times longer induction time than the control sample.

### Example 8

50 mL of vegetable oil were added to 1 g of rosemary extract containing 20% by weight of carnosic acid, 5% by weight of carnosol and 3% by weight of methyl-carnosol and the mixture was stirred for 15 minutes at a temperature of 60° C.

Flax seeds were sprinkled with a solution of rosemary extract in vegetable oil so that the concentration of rosemary extract in comparison to the fat content of the flax seeds was 0.005% (0.05 g/kg), 0.02% (0.2 g/kg) and 0.1% (1 g/kg).

The flax seeds were mixed well and kept at room temperature for two months. A control sample was prepared by the same procedure, without addition of an antioxidant. When the storage period was over, fat was isolated by extraction and the oxidation status was measured by a Rancimat test.

The sample with the added rosemary extract in a concentration of 0.02% (0.2 g/kg) had by 2.6-times longer induction time than the control sample.

### Example 9

100 g of peeled peanuts were roasted in 5 g of vegetable oil, to which rosemary extract was added (20% by weight of carnosic acid, 5% by weight of carnosol and 3% by weight of methyl-carnosol) so that the concentration of rosemary extract in comparison to the fat content of the peanuts and oil for roasting was 0.005% (0.05 g/kg), 0.02% (0.2 g/kg) and 0.1% (1 g/kg).

After roasting, the peanuts were kept at room temperature for two months. A control sample was prepared by the same procedure, without addition of an antioxidant to the oil. When the storage period was over, fat was isolated by extraction and the oxidation status was measured by a Rancimat test.

The sample with the added rosemary extract in a concentration of 0.02% (0.2 g/kg) had by 2.3-times longer induction time than the control sample.

1. A method for stabilization and protection of whole, broken or ground nuts, seeds and/or of products containing the same, comprising mixing the whole, broken or ground nuts, seeds and/or products containing the same with a composition in a form of a powder or solution, which comprises an antioxidant extract of at least one plant from the Labiatae family.

2. The method according to claim 1, wherein the composition comprises a diluent.

3. The method according to claim 2, wherein the diluent is selected from maltodextrin, salt, sugar, a condiment, edible oil, or any other food approved diluent or any combination thereof.

4. The method according to claim 2, wherein the amount of the diluent is from about 90% to 99% of the composition.

5. The method according to claim 1, wherein the composition comprises from about 0% to 50% by weight of carnosic acid, from about 0% to 10% by weight of carnosol and from about 0% to 6% by weight of methyl-carnosol.

6. The method according to claim 1, wherein the composition is added to the nuts, seeds, and/or products comprising the same, in a concentration of from about 0.005% to 0.1% by weight with respect to the fat.

7. (canceled)

8. (canceled)

9. The method according to claim 1, wherein the solution form comprises ethanol or edible oil.

10. The method according to claim 1, wherein the composition is applied to the nuts or seeds during their roasting or coating with additional fat.

11. The method according to claim 1, wherein the composition is applied to the nuts or seeds during their roasting without additional fat.

12. The method according to claim 1, wherein an emulsifier is added to the composition.

13. The method according to claim 12, wherein the emulsifier is DATEM.

14. The method according to claim 12, wherein the emulsifier is added in an amount of from about 0.5% to 5% by weight.

15. The method according to claim 1, wherein the composition is added to an ingredient of a product, wherein the final product will contain nuts and/or seeds.

16. The method of claim 1, comprising the steps of applying the composition, which is a solution of rosemary extract in ethanol, to the whole, broken or ground nuts, seeds and/or products containing the same and drying at a temperature ranging from about 20° C. to 60° C.

17. The method of claim 1, comprising the steps of applying the composition, which is in a form of a solution comprising edible oil, to the whole, broken or ground nuts, seeds and/or products containing the same.

18. The method of claim 1, comprising the steps of applying the composition, which comprises maltodextrin, to the whole, broken or ground nuts, seeds and/or products containing the same.
